(19) United States
(12) Patent Application Publication
(10) Pub. No.: US 2026/0208114 A1
(43) Pub. Date: Jul. 23, 2026

(54) TANGENTIAL FLOW FILTER WITH COMBINED PERMEATE OUTPUTS AND METHOD OF FILTERING

(71) Applicant: EMD Millipore Corporation, Burlington, MA (US)

(72) Inventors: John Cieciuch, Dracut, MA (US); Alison Dupont, Lyndeborough, NH (US); Joseph William Muldoon, Berlin, MA (US); Joseph Sinagra, Groton, MA (US)

(21) Appl. No.: 19/142,294

(22) PCT Filed: Jan. 2, 2024
(86) PCT No.: PCT/US2024/010047

§ 371 Date: Jun. 23, 2025

Related U.S. Application Data
(60) Provisional application No. 63/436,781, filed on Jan. 3, 2023.

(51) Int. Cl. B01D 63/08

(52) U.S. Cl. CPC B01D 63/0822; B01D 63/084; B01D 2313/21; B01D 2315/10

(57) ABSTRACT

Tangential flow filter including first and second endcaps, one having a feed inlet and retentate and permeate outlets, and one or more pairs of plates between the endcaps. Each plate has a respective membrane bonded to each side. A first series of openings are formed through a first plate; a second series of openings are formed through a second plate; a third series of openings are formed through the first plate; and a fourth series of openings are formed through the second plate and communicate with the third series of openings. The third and fourth series of openings are positioned in respective permeate channels in the respective regions of one side of the first plate and one side of the second plate that are devoid of filtration media. The permeate channel is in fluid communication with the permeate outlet.

This application claims priority of U.S. Provisional Application Ser. No. 63/436, 781 filed Jan. 3, 2023, the disclosure of which is incorporated herein by reference in its entirety.

### FIELD

Embodiments of the technologies disclosed herein relate to filters and filtration systems useful in bioprocessing.

### BACKGROUND

Filtration via membranes is a separation technique used for bench scale as well as process scale purification of biological materials. There are different types of membranes used in filtration, which may be classified as microfiltration or ultrafiltration membranes depending on the pore size. Microfiltration membranes generally have pore size ranging between 0.1 microns (μm) and 10 μm. Ultrafiltration membranes have a smaller pore size, typically ranging between 0.001 and 0.1 μm. Because of the difference in the pore size, these membranes are used for different purposes. For example, microfiltration membranes are generally used for clarification, sterilization, and removal of micro-particulates or for cell harvesting. Ultrafiltration membranes are generally used for fractionation or for concentrating molecules (e.g., proteins, peptides, nucleic acids, carbohydrates, and other biological materials). Ultrafiltration membranes are typically classified by molecular weight cutoff, e.g., kiloDaltons (kDa), rather than pore size.

There are two main types of filtration modes or processes that are used with microfiltration and ultrafiltration membranes. A first filtration mode is called Normal Flow Filtration (NFF) mode, also known as “dead-end” filtration, which generally applies the feed stream perpendicular to the membrane face and attempts to pass 100% of the fluid through the membrane. A second filtration mode is called Tangential Flow Filtration (TFF), where the feed stream is parallel to the membrane face, where one portion passes through the membrane (i. e., permeate) while the remainder is retained and may be recirculated back to the feed reservoir (i.e., retentate).

Tangential flow filtration (TFF) devices, also known as cross-flow filtration devices, have one feed inlet, one retentate outlet and at least one permeate outlet. Tangential flow denotes a filtration configuration in which a flowing fluid is directed along the surface of a filter medium, substantially parallel (tangential) to the surface of the filter medium. In this configuration, the solute adsorbs or absorbs to the surface or the pores of the membrane as the eluent flows over the surface. The purified portion of fluid that passes through such filter medium has a velocity component which is “cross-wise”, i.e., perpendicular to the direction of the fluid flowing along the surface of such filter medium. In TFF, the retentate (or decantate) can be repeatedly re-circulated with the objective of improving filtration efficiency and enhancing the permeate yield. The re-circulated retentate solution pathway runs parallel to the membrane surface and is pumped past the membrane with sufficient velocity to ensure a surface cleaning action. However, only a relatively small amount of permeate is collected during each retentate volume-pass, and thus a significant processing time is typically associated with TFF procedures. If an appropriate membrane is selected for a specific separation, a second liquid can be used to elute the material adsorbed or absorbed to the membrane for harvesting.

Crossflow filtration or tangential filtration is a well-known filtration process. Reference may be had e.g., to U.S. Pat. Nos. 5,681,464, 6,461,513; 6,331,253, 6,475,071, 5,783,085, 4,790,942, the disclosures of which are incorporated herein by reference.

TFF filtration is often preferred for the purification of certain types of biological materials, for example, biological materials having a size of 500 kDa or larger, where TFF is used for concentration and impurity clearance. Most TFF processes use ultrafiltration membranes for concentration and buffer exchange steps, etc. One example of an ultrafiltration membrane which is used in TFF mode for manufacturing of certain biological materials (e.g., proteins, vaccines and virus-like particles) is a solution immersion cast ultrafiltration membrane made from polyethersulfone (PES).

Tangential flow filtration (TFF) is a separation process that uses membranes to separate components in a liquid solution or suspension on the basis of size, molecular weight or other differences. TFF is used in perfusion processes to remove target proteins from cell culture media, while retaining cells within the media. In TFF processes, fluid is pumped tangentially along the membrane surface and particles, molecules, or cells that are too large to pass through the membrane are rejected and returned to a process tank. TFF processes can involve additional passes of the fluid across the membrane (e.g., recirculation) until the process fluid is sufficiently clarified, concentrated or purified. The cross-flow nature of TFF minimizes membrane fouling, thus permitting high volume processing per batch. The membranes are contained within filter elements that can be of a variety of configurations, such as spiral-wound filter elements and cassette filter elements.

Monoclonal antibodies (mAbs) are used as therapeutic agents for a variety of indications, including, for example, cancer, transplant rejections, and cardiovascular disease. Various biopharmaceutical manufacturing techniques exist to produce and harvest mAbs from host cells, including, for example, fed-batch processes and perfusion processes. In fed-batch bioreactor systems, cells are cultured in batches over a set period of time, for example, over about seven to about twenty-one days, after which point media nutrients have been consumed by the host cells and waste products have accumulated. Following the cell culture period, the batch undergoes a harvesting step in which the protein of interest (e.g., a product, such as a monoclonal antibody, or mAb) is separated from the cell mass. In contrast with fed-batch systems, perfusion bioreactors culture cells over longer periods of time, for example, over several weeks or months, while continuously feeding cells with fresh media, removing spent media, and harvesting product. Perfusion systems offer several advantages over fed-batch systems. For example, as product is harvested and purified on a continuous basis, before the proteins of interest are exposed to high levels of waste, product degradation is reduced in perfusion systems. In addition, a perfusion bioreactor can produce a similar product yield as a fed-batch bioreactor while occupying a significantly smaller space. Perfusion is becoming a preferred manufacturing technique in the biopharmaceutical industry due to its advantages over batch-fed processes. However, perfusion processes rely on a high density of host cells being maintained throughout each production process, and continuous harvesting, which involves several iterations of filtration, and can cause physical damage to the host cells.

Conventional TFF devices may be composed of a plurality of elements, including a pump, a feed solution reservoir, a filtration module and conduits for connecting these elements. In use, the feed solution is directed from the feed solution reservoir to the filtration module while the retentate from the filtration module is recirculated from the filtration module to the feed solution reservoir until the desired volume of retentate is obtained. The membrane is sandwiched between top and bottom manifolds or holders, which serve to provide accurate mechanical constraint against the internal hydraulic pressure of the device, and also serve to distribute the filtration stream across the multiple flow paths within the device.

Prior art tangential flow filter devices combine permeate outputs that are external to the filter housing or module. Also, prior art tangential flow filter devices do not provide multiple internal permeate flow paths. A tangential flow filter having filtration media on each endcap, and both sides of any plates within the filter stack, wherein permeate flows for each endcap and plate are cooperative within the filter, allowing for a single permeate output from the filter, represents an advance in the art.

### SUMMARY

In some embodiments, disclosed is a tangential flow filter housing or module for filtration of a fluid, comprising first and second endcaps, the first endcap having a fluid feed inlet, a retentate outlet and a permeate outlet; at least first and second plates, each plate having a first side and an opposite second side, the first side of the first plate facing the first endcap and having a first effective filtration area, the second side of the first plate facing the first side of the second plate and having a second effective filtration area less than the first effective filtration area; filtration media between the first endcap and the first plate, between the first plate and the second plate, and between the second plate and the second endcap; a first series of spaced openings through the first plate; a second series of spaced openings through the second plate aligned or in fluid communication with the first series of spaced openings in the first plate; a third series of spaced openings through the first plate spaced from the first series of spaced openings; a fourth series of openings through the second plate aligned or in fluid communication with the third series of openings in the first plate; wherein the third and fourth series of spaced openings are positioned in respective permeate channels in the respective regions of the second side of the first plate and the first side of the second plate that are devoid of filtration media, these regions being opposite respective filtration media on the first side of said first plate and the second side of the second plate; the permeate channel being in fluid communication with the permeate outlet. In some embodiments, the second effective filtration area may be the same or greater than the first effective filtration area. In some embodiments, the membrane (and/or a screen) on one side of a plate may extend laterally (i.e., the shorter axis of the device) a greater distance than the membrane and/or a screen on the other side to accommodate a permeate flow channel.

In some embodiments, the openings of the first series of spaced openings are lineally aligned with each other. In some embodiments, the openings of the third series of spaced openings are lineally aligned with each other.

In some embodiments, the filtration media between the first endcap and the first plate comprises a first membrane attached to the endcap and a second membrane attached to the first side of the first plate. In some embodiments, there may be a screen between the first and second membranes.

In some embodiments, fluid passing through the second membrane flows through the third series of spaced openings and enters the permeate channel. In some embodiments, fluid passing through the first membrane enters the permeate outlet.

In some embodiments, the filtration media between the first plate and the second plate comprises a third membrane attached to the second side of the first plate and a fourth membrane attached to the first side of the second plate. In some embodiments, fluid passing through the third and fourth membranes enters each respective first and second series of spaced openings and flows to the third and fourth series of spaced openings.

In some embodiments, there are a plurality of stacks of plates between the first and second endcaps. Thus, instead of the second plate being attached to the second endcap, it is attached to a third plate, the third plate being one of a pair of plates in a second stack of plates, with the other of the pair of plates being attached to the second endcap or a fifth plate that is one of yet another pair of plates, etc.

Certain embodiments relate to a method of filtering a fluid sample. In some embodiments, disclosed is a method of filtering a fluid sample, comprising: introducing the fluid sample into a feed inlet of a first endcap; causing the introduced fluid sample to:
(a) contact a first membrane attached to the first endcap to form a first permeate flow and a first retentate flow, the first permeate flow flowing to a first permeate outlet of the first endcap or to a second permeate outlet of a second endcap, and the first retentate flow flowing to a first retentate outlet of the first endcap or a second retentate outlet of said second endcap;
(b) contact a second membrane attached to a first side of a first plate attached to the first endcap to form a second permeate flow and a second retentate flow, the second permeate flow flowing to a first spaced plurality of permeate ports formed in the first plate that are in fluid communication with a permeate channel and said first or second permeate outlet, the second retentate flow flowing to the first or second retentate outlet;
(c) contact a third membrane attached to a second side of the first plate to form a third permeate flow and a third retentate flow, the third permeate flow flowing to a second spaced plurality of permeate ports formed in the first plate and combining with the second permeate flow prior to the second permeate flow entering the first spaced plurality of permeate ports that are in fluid communication with said permeate channel and said first or second permeate outlet, the third retentate flow flowing to the first or second retentate outlet;
(d) contact a fourth membrane attached to a first side of a second plate attached to the first plate to form a fourth permeate flow and a fourth retentate flow, the fourth permeate flow flowing to a third spaced plurality of permeate ports formed in the second plate and in fluid communication with a fourth spaced plurality of ports in fluid communication with said permeate channel and said first or second permeate outlet, said forth retentate flow flowing to said first or second retentate outlet;
(e) contact said fifth membrane attached to a second side of the second plate to form a fifth permeate flow and a fifth retentate flow, the fifth permeate flow flowing to said fourth spaced plurality of permeate ports formed in the second plate that are in fluid communication with said permeate channel and said first or second permeate outlet, the fifth retentate flow flowing to the first or second retentate outlet; and
(f) contact a sixth membrane attached to a second endcap to form a sixth permeate flow and a sixth retentate flow, the sixth permeate flow flowing to a permeate pipe, conduit or the like, in fluid communication with said permeate channel and said first or second permeate outlet and the sixth retentate flow flowing to the first or second retentate outlet; and
collecting permeate flow from the permeate outlet.

For clarity purposes, six retentate flows are defined above. Note, however, that the first and second flows are effectively the same flow, as each flows between a gap between membranes on the first endcap and on the first side of the first plate. Neither passes through a membrane, so they enter the device as the feed at one end of a membrane, flow across it, and exit at the retentate outlet. They are separated from each other only by the screen, where present, which is open. The same is true for the third and fourth retentate flows and the fifth and sixth retentate flows. Thus a device with one pair of plates has a total of six permeate flows, through the six membranes, but effectively has only three retentate flows (see FIG. 7).

In some embodiments, retentate flow may be collected from the retentate outlet, recycled to the feed inlet, or both.

Some embodiments of the disclosure describe tangential flow filtration devices wherein all permeate flows can be merged within the filter device or housing, e. g., within the region defined between the two endcaps. Some embodiments of the disclosure describe devices wherein all permeate flows exit through a single location. Some embodiments of the disclosure describe devices wherein all permeate flows can be merged within the filter device and wherein all permeate flows exit through a single location. Some embodiments of the disclosure describe devices wherein external tubing requirements are reduced, eliminating the risk of one permeate output tube's flow being restricted, which would otherwise alter a flow pattern within the filter device. Some embodiments of the disclosure describe devices where there is an active membrane on each side of an endcap and plate which during operation of the device contacts fluid.

In some embodiments, TFF devices are used as part of a perfusion bioreactor, wherein process media flows through the TFF device(s), entering via a feed input. Cells and process media are returned to a bioreactor, which supplies the TFF device, via a retentate output, wherein materials produced by the cells, i.e., a biological product, are collected via a permeate output.

In a further embodiment, a perfusion system is disclosed that includes at least one filter element as described herein and a pump configured to control flow of a liquid feed through the at least one filter element.

In yet another embodiment, a perfusion process is disclosed that includes passing a liquid feed through a feed channel of at least one filter element and separating the liquid feed into permeate and retentate by tangential flow filtration (TFF) in the filter element. Filtration media capable of separating the liquid sample into a retentate stream and a permeate stream upon passage of said liquid sample into the tangential flow filtration module through the feed inlet is provided.

In another embodiment, a perfusion process for harvesting target proteins from a liquid feed containing host cells is disclosed. The process includes delivering a liquid feed containing target proteins and host cells to a feed channel of at least one filter element and separating the target proteins from the host cells in the at least one filter element. The target proteins can be, for example, monoclonal antibodies, which can be separated from the host cells by TFF and recovered from the at least one filter element. The perfusion process can further include recovering the host cells from the at least one filter element, supplying a volume of fresh media to the recovered host cells, and returning the recovered host cells to a bioreactor. The perfusion process can be run on a continuous basis, with the recovered host cells of an initial perfusion run being the liquid feed of a subsequent perfusion run.

### BRIEF DESCRIPTION OF THE DRAWINGS

FIG. 1 is a perspective view of a tangential flow filtration assembly according to some embodiments of the disclosure;

FIG. 2 is a perspective view of the tangential flow filtration assembly of FIG. 1 with the outer housing removed, according to some embodiments of the disclosure;

FIG. 3A is a front view of the tangential flow filtration assembly of FIG. 2, according to some embodiments of the disclosure;

FIG. 3B is a top view of the tangential flow filtration assembly of FIG. 2, according to some embodiments of the disclosure;

FIG. 3C is a bottom view the tangential flow filtration assembly of FIG. 2, according to some embodiments of the disclosure;

FIG. 3D is a first side view of the tangential flow filtration assembly of FIG. 2, according to some embodiments of the disclosure;

FIG. 3E is a second side view of the tangential flow filtration assembly of FIG. 2, according to some embodiments of the disclosure;

FIG. 4 is an exploded view of the tangential flow filtration assembly of FIG. 2, according to some embodiments of the disclosure;

FIG. 5A is a view of the underside of an endcap according to some embodiments of the disclosure;

FIG. 5B is a perspective view of the endcap of FIG. 5A, with a membrane attached according to some embodiments;

FIG. 5C is a side view of the endcap of FIG. 5A;

FIG. 6A is a top view of a first surface or face of an inner plate according to some embodiments of the disclosure;

FIG. 6B is a top view of a second surface or face of an inner plate according to some embodiments of the disclosure;

FIG. 7 is a cross-sectional view of a pair of inner plates sandwiched between two endcaps according to some embodiments of the disclosure;

FIG. 8 is a sectional view of an endcap permeate outlet and feed inlet showing permeate flow in accordance with certain embodiments;

FIG. 9A is a top view of an inner plate with a membrane in accordance with certain embodiments;

FIG. 9B is a cross-sectional view of a portion of the inner plate of FIG. 9A;

FIG. 10 is a cross-sectional view of a portion of a pair of inner plates sandwiched between two endcaps according to some embodiments of the disclosure;

FIG. 11 is a detailed view of a portion of FIG. 10 according to some embodiments of the disclosure;

FIG. 12A is a perspective view of a manifolded assembly in accordance with certain embodiments;

FIGS. 12B and 12C are perspective views of internal details of the manifolded assembly of FIG. 12A;

FIG. 13 is a view of an endcap with straps affixed in accordance with certain embodiments;

FIG. 14 is a cross-sectional view of a portion of a pair of inner plates sandwiched between two endcaps according to some embodiments of the disclosure;

FIG. 15A is aa top view of an endcap in accordance with certain embodiments;

FIG. 15B is a side view of the endcap of FIG. 15A, taken along line BG-BG of FIG. 15A;

FIG. 15C is an enlarged view of detail AZ of FIG. 15A;

FIG. 15D is an enlarged view of detail BB of FIG. 15B;

FIG. 16A is a top view of a first surface or face of an inner plate according to some embodiments of the disclosure;

FIG. 16B is a top view of a second surface or face of the inner plate of FIG. 16A according to some embodiments of the disclosure;

FIG. 16C is a side view of the inner plate of FIG. 16B taken along line AP-AP;

FIG. 16D is an enlarged view of detail AV of FIG. 16C; and

FIG. 16E is an enlarged view of detail AW of FIG. 16A.

### DETAILED DESCRIPTION

Although specific terms are used in the following description for the sake of clarity, these terms are intended to refer only to the particular structure of the embodiments selected for illustration in the drawings. In the drawings and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s), ” “include(s), ” “having,” “has,” “can,” “contain (s),” and variants thereof, as used herein, are intended to be open-ended transitional phrases, terms, or words that do not preclude the possibility of additional components.

All ranges disclosed herein are inclusive of the recited endpoint and independently combinable (for example, the range of “from 2% to 10” is inclusive of the endpoints, 2% and 10%, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.”

It should be noted that some terms used herein are relative terms. For example, the terms “upper” and “lower” are relative to each other in location, i.e. an upper component is located at a higher elevation than a lower component, and should not be construed as requiring a particular orientation or location of the structure. As a further example, the terms “interior”, “exterior”, “inward”, and “outward” are relative to a center, and should not be construed as requiring a particular orientation or location of the structure.

The terms “top” and “bottom” are relative to an absolute reference, i.e. the surface of the earth. Put another way, a top location is always located at a higher elevation than a bottom location, toward the surface of the earth.

“TFF assembly,” “TFF system” and “TFF apparatus” are used interchangeably herein to refer to a tangential flow filtration system that is configured for operation in a recirculation mode where at least a portion of the retentate is returned to the system as feed.

“Feed line” or “feed channel” refers to a conduit for conveying a feed from a feed source (e. g., a feed container) to one or more processing units in a filtration assembly.

“Retentate line” or “retentate channel” refers to a conduit in a filtration assembly for carrying retentate.

“Permeate line” or “permeate channel” refers to a conduit in a filtration assembly for carrying permeate.

“Filtration membrane” or “membrane” refers to a selectively permeable membrane for separating a feed into a permeate stream and a retentate stream using an SPTFF or a TFF process. Filtration membranes include, but are not limited to, ultrafiltration (UF) membranes, microfiltration (MF) membranes, reverse osmosis (RO) membranes and nanofiltration (NF) membranes. The terms “ultrafiltration membrane” and “UF membrane” are used herein to refer to a membrane that has pore sizes in the range of between about 1 nanometer to about 100 nanometers. The term “microfiltration membranes” and “MF membranes” are used herein to refer to membranes that have pore sizes in the range between about 0.1 micrometers to about 10 micrometers.

Flat plate or cassette devices comprise or consist of membranes cast on plates; the plates are then reliably stacked. The devices may or may not have flexible screens in the feed channels to support the membranes. An appealing advantage of a configuration such as this is its very compact design. However, channel height control, defined by plate-to-plate interaction and distance, must be very carefully considered. Straps may be used to help achieve consistent channel height control.

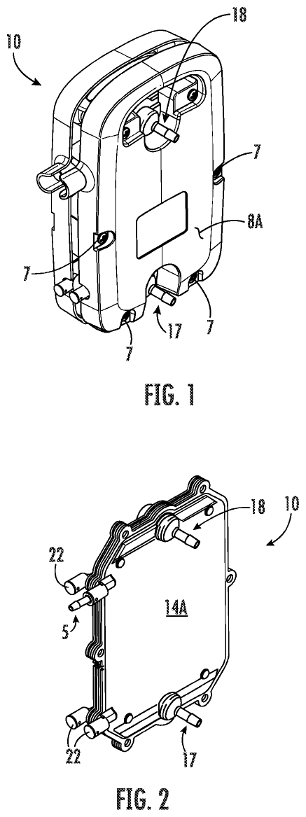

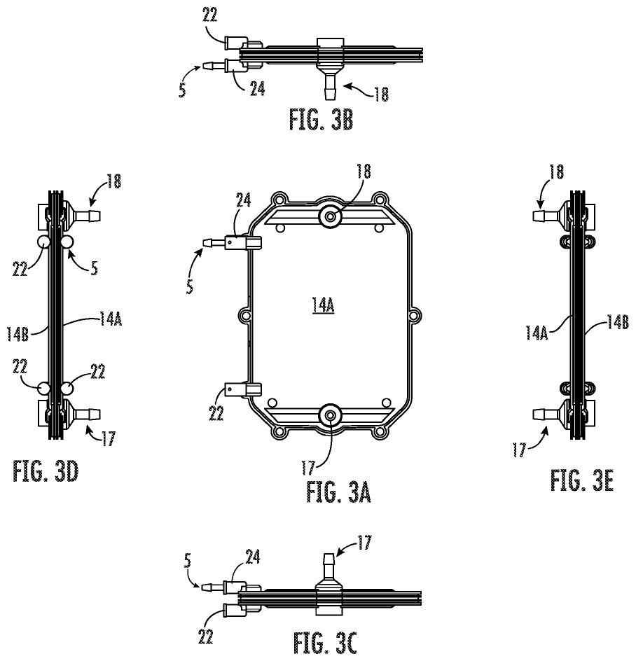

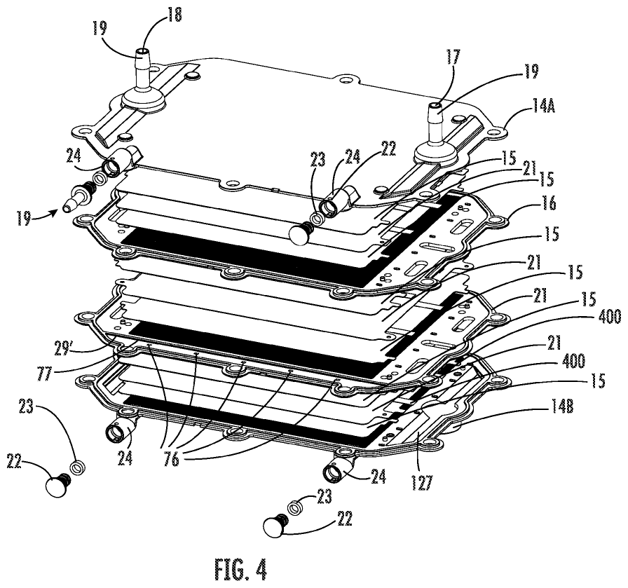

Turning now to FIGS. 1-4, according to some embodiments, a tangential flow filtration assembly or housing 10 comprises two spaced endcaps 14A, 14B having one or multiple pairs of plates 16 disposed between the endcaps 14A, 14B, wherein each plate 16 has a first major side surface and a second major side surface. In some embodiments, each plate 16 is made of a fluid impervious material (e. g., polypropylene) and may comprise a filtration media, e. g., a membrane 15 (e. g., a PVDF or PES membrane), disposed on each of the first major side surface and the second major side surface such as by heat bonding. In certain embodiments, a turbulence-promoting screen 21 is juxtaposed to each membrane such that every flow channel includes a screen 21. Suitable screens 21 include those commercially available from EMD Millipore Corporation and include those conventionally sold with PELLICON® 3 cassettes, such as A screens (tight screens), C screens (coarse screens) and D screens (coarse screens for high viscosity). The screens also function to prevent adjacent membranes from contacting each other. For assembly purposes, the screens may have suitably positioned apertures to receive alignment pins or similar features on the endcaps and inner plates, whereas the membranes may have rounded shoulder features to help properly position the membrane near the pins while avoiding membrane wrinkling. In certain embodiments, there may be two different screen shapes, the same way that there may be two different membrane shapes; one for the endcaps and one side of the inner plates, and a different shape for the other side of the inner plates. For conciseness, the reference numbers assigned in FIG. 4 (15 for membrane, 21 for screen) don't reflect the different unique screen and membrane shapes. The plates 16 are generally assembled as pairs within a stack, e. g., one pair of plates 16, two pairs or plates 16, three pairs of plates 16, to any suitable amount of pairs of plates. As many as 13 or more pairs of plates may be suitable in a device. Preferably the plates 16 are equally dimensioned. In some embodiments, an overall layout of the endcaps and plates are similar or the same. For simplicity of manufacture, the endcaps 14A, 14B may all be identical, and may include multiple ports 24, some of which may be unused and thus blocked with a suitable plug, such as a permeate plug 22 and associated seal such as O-ring(s) 23. Ports 24 that are operational may be fitted with a suitable barb fitting 19 and O-rings 23, for example. Overcaps 8A, 8B (FIG. 1), such as stiff plastic plates or the like that are coupled around the device with fasteners 7 such as bolts may be used to help prevent the device from bulging when under operating pressures. In some embodiments, the unused ports may simply be eliminated.

A feed of biological fluid or other sample fluid enters at a feed input or inlet 17 of the TFF device 10, flowing across the filtration media in the device or housing in a tangential flow mode to a retentate outlet 18. In some embodiments, the filtration media are membranes capable of separating the fluid sample into a retentate stream and a permeate stream upon passage of the fluid sample into the tangential flow filtration device through the feed inlet 17. The fluid passing through the filtration media, i.e., a permeate, is combined into a single location within the TFF device, irrespective of which endcap 14A, 14B or plate 16 the biological fluid flowed through. For each plate 16, the permeate flow(s) on either side of the plate is joined and flows to a permeate flow channel 77. As a result, regardless of which endcap or plate the permeate flows through, or where this occurs in each endcap or plate, all permeate flow(s) is connected within the TFF device and exits through a single location, e.g., a permeate outlet 5, such as through a barb fitting, for example. In some embodiments, the TFF assembly 10 comprises two endcaps 14A, 14B. In some embodiments, identically configured endcaps can be used, with one of the endcaps having a feed input and a retentate outlet with barbs or similar structure, and the other endcap being closed off such as with suitable plugs so that no feed or retentate fluid enters or exits at those locations, or this other endcap has no output locations. Feed and retentate barb sizes may be modified to accommodate different flow rates.

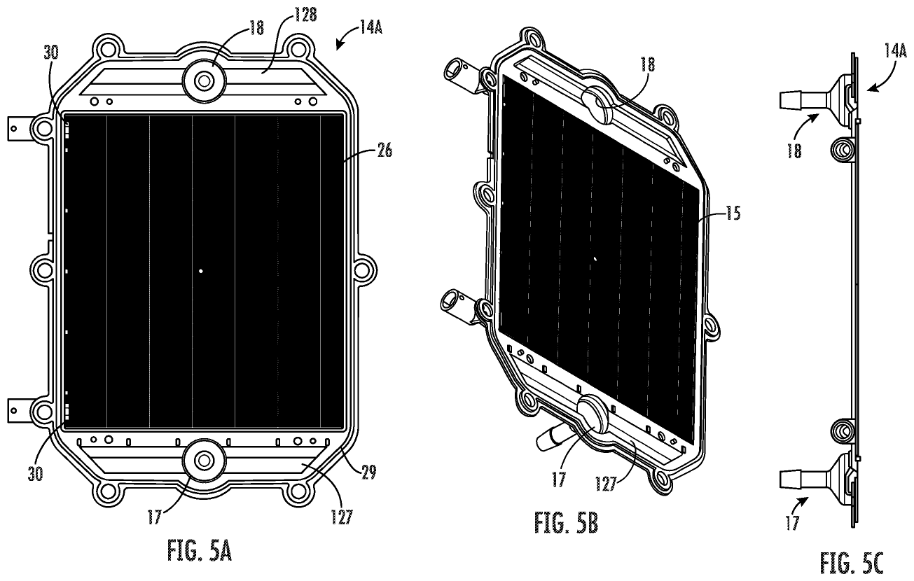

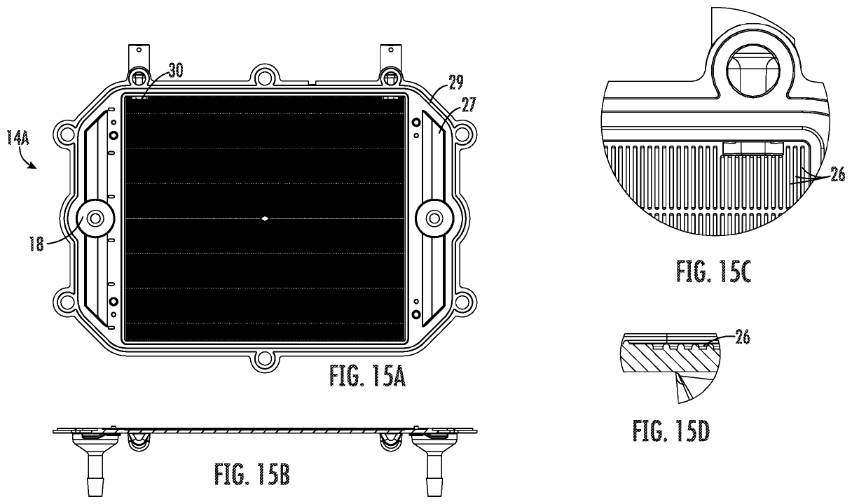

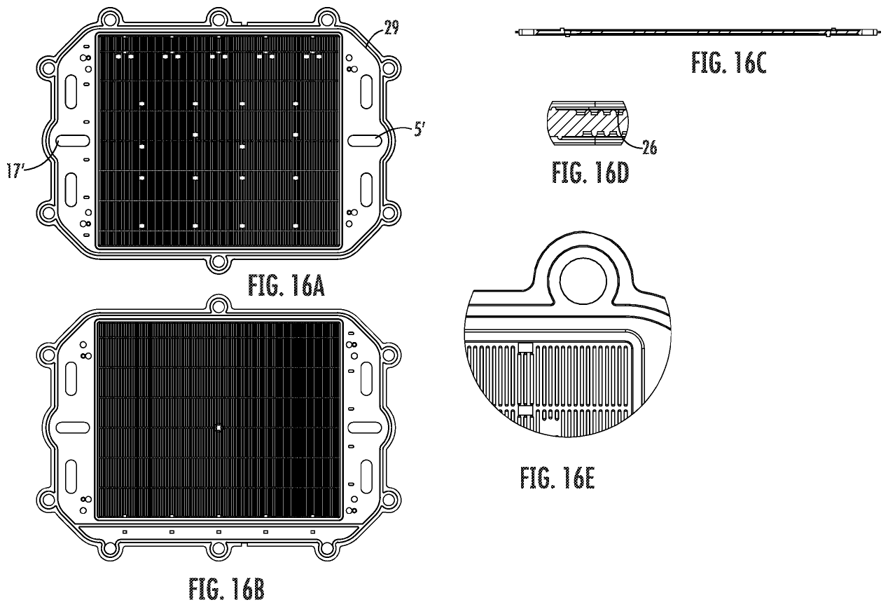

FIGS. 5A and 5B show an embodiment of endcap 14A, which may be identical to endcap 14B. In the embodiment shown, the visible surface or face is an inner surface or face (i.e., it faces inwardly in the assembled apparatus) and has a functional geometry providing a membrane effective area. As seen in FIG. 4, the opposite or outer surface or face of the endcap 14A does not contact process fluid and thus may be devoid of functional geometry such as ribs. In some embodiments, the functional geometry of the inner surface includes a plurality of spaced ribs 26 that are elongated and extend above the inner surface and that both support a membrane (membrane shown in FIG. 5B) bonded or otherwise attached to the endcap 14A, and provide a region between the ribs 26 and the membrane for fluid flow. Gaps shown between groups of ribs may be present to improve flow. In some embodiments, the plurality of spaced ribs 26 are arranged in spaced columns, with each rib 26 in a column being spaced from an adjacent rib 26 in the same column. In certain embodiments, the ribs 26 in each column are equally spaced and sized, and the spaces between columns are equal. Other rib geometries and configurations may be used. In certain embodiments, the ribs 26 may be 0.020″ high and 0.026″ wide (in the narrow direction, cutting across the rib), with a 0.026″ gap between them. Details of the endcap 14A ribs are shown in FIGS. 15A, 15B, 15C and 15D, and details of the ribs of an inner plate 16 are shown in FIGS. 16A, 16B and 16C. The endcap 14A may be attached to an inner plate 16, such as with heat bonding via a bond rim 29 formed just inside a perimeter of at least a portion of the endcap 14A, and which preferably spans inside the entire perimeter as shown. The bond rim 29 extends upwardly from the inner face surface of the endcap. Accordingly, the surface or face is configured to mate with an inner plate 16 as discussed in greater detail below. As permeate fluid flows through the membrane 15, it flows along the region between the underside of the membrane 15 and the plurality of spaced ribs 26, to openings 30 which lead to the permeate outlet 5 (and then through barb 19, for example) or to permeate plug 22. For certain openings 30 at the plugs 22, permeate flows to permeate pipe feature 60, then to permeate flow channel 77, in order to flow to the barb 19. Thus, the openings 30 are in fluid communication with the region between the ribs 26 and the membrane 15, and with the permeate outlet 5 (or permeate plug 22 where fluid dead ends). Respective feed and retentate grooves, troughs or cavities 127, 128 may be provided in fluid communication with the feed inlet 17 and retentate outlet 18 as shown.

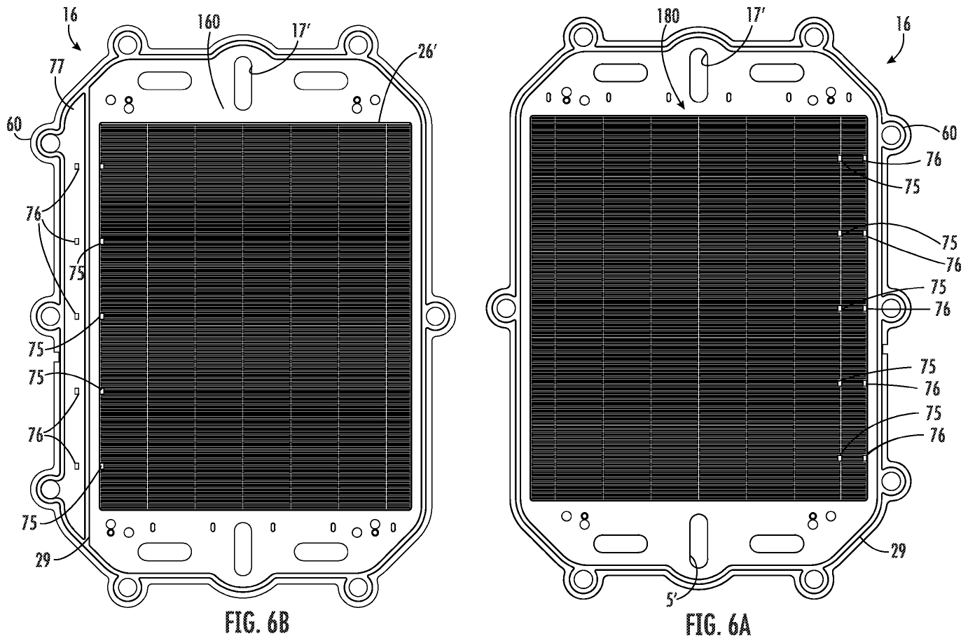

FIG. 6A shows the first surface or face 180 of the plate 16, which has a functional geometry including a plurality of spaced elongated ribs that match the functional geometry of the inner surface of the endcap 14A or to another first face of a further pair of inner plates 16. In some embodiments, the first surface or face 180 of the inner plate 16 has a larger effective membrane area than that of the second surface or face 160 of the inner plate 16, and has the same effective membrane area as the inner surface of the endcap 14A shown in FIG. 5A. Thus, as seen by a comparison of FIGS. 6A and 6B, the effective membrane area (and thus the plurality of ribs 26) of the first surface or face 180 extends laterally closer to the outer perimeter on the left side of FIG. 6A than does the effective area (and thus the plurality of ribs 26′) of the second surface or face 160 of the inner plate 16. Like the ribs 26 of the endcap 14A discussed above, a plurality of spaced ribs 26 are formed on the surface or face 180, extend upwardly therefrom, and are arranged in spaced columns, with each rib 26 in a column being spaced from an adjacent rib 26 in the same column. In certain embodiments, the ribs 26 in each column are equally spaced and sized, and the spaces between columns are equal. In certain embodiments, the ribs 26 are larger than the ribs 26′; there are fewer ribs 26 per column height than there are ribs 26′. The first face 180 of the inner plate 16 is configured to be bonded or otherwise attached to the endcap 14A or to another second face of a further pair of inner plates 16, such as via a bond rim 29 formed just inside a perimeter of at least a portion of the inner plate 16 as shown. The first surface or face 180 of inner plate 16 may also have a screen 21 (FIG. 4) positioned over the membrane; every flow channel generally includes a screen 21. In some embodiments, one or more narrow plastic (e.g., polypropylene) straps 400 or the like (FIG. 13, shown on an endcap) may be positioned over the membrane and affixed to the plate surface outside the effective membrane area in order to achieve more uniform and/or consistent channel heights (e.g., the height between each pair of members, e.g., between and endcap and a plate, or between two plates, and better device performance. In some embodiments, the straps are heat bonded on top of the membrane. In some embodiments, two straps per membrane may be used.

FIG. 6B shows an embodiment of inner plate 16. In the embodiment shown, the visible surface or face is a second surface or face 160 and has a functional geometry including a plurality of spaced ribs 26′that support a membrane (not shown). In some embodiments, the second surface or face 160 of the inner plate 16 has a smaller effective membrane area than that of the inner surface of the endcap 14A shown in FIG. 5A (and, similarly, smaller than the effective membrane area of the opposite or first surface or face 180 of the inner plate 16 shown in FIG. 6A). The second surface or face 160 is configured to mate and bond, such as with heat bonding, with a corresponding surface or face of a second plate 16 to form a pair of plates. Like the ribs 26 of the endcap 14A discussed above, a plurality of elongated spaced ribs 26′are formed on the surface or face 160 and are arranged in spaced columns, with each rib 26′in a column being spaced from an adjacent rib 26′in the column. In certain embodiments, the ribs 26′in each column are equally spaced and sized, and the spaces between columns are equal. In certain embodiments, the ribs 26′ are smaller than the ribs 26; there are more ribs 26′per column height than there are ribs 26. In some embodiments, the second surface of face 160 also includes an additional bond rim 29′ traversing a length of the inner plate 16. The additional bond rim 29′separates a first spaced plurality or series of permeate ports 75 positioned along a column of ribs within the effective membrane area from a second spaced plurality or series of permeate ports 76 positioned laterally spaced from the first spaced plurality of permeate ports 75 and outside of the effective membrane area. In certain embodiments, the first spaced plurality of permeate ports are linearly aligned with each other. In certain embodiments, the second spaced plurality of ports 76 may be linearly aligned with each other. When two plates 16 are assembled in a pair, the number of ports 75 in the first of the two plates may match the number of ports 75 in the second of the two plates, each port 75 in the first plate aligning with a respective port 75 in the second plate, and the number of ports 76 in the first of the two plates matches the number of ports 76 in the second of the two plates, each port 76 in the first plate aligning with a respective port 76 in the second plate. In other embodiments, the spaced plurality of ports 76 may not be linearly aligned. Also in other embodiments, the number of ports 75 may be different from the number of ports 76. The additional bond rim 29′delineates a permeate flow channel 77 and keeps unfiltered feed/retentate liquid out of that lengthwise channel where the permeate liquid can flow towards the permeate “pipes” or pipe features 60, heading eventually towards the permeate outlet 5 in fluid communication therewith, as shown by arrows 206. The width of the permeate flow channel 77 should be sufficient so as to avoid being closed off by melted plastic that might penetrate out of the bond rims as the plates are bonded together.

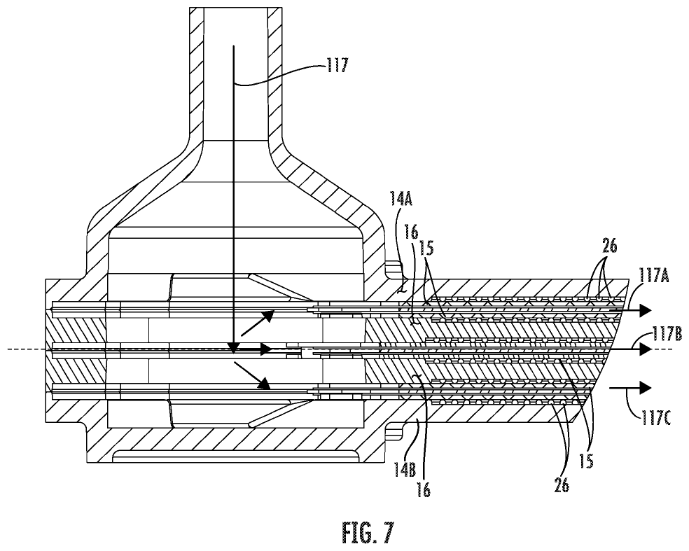

Turning now to FIG. 7, the flow of sample feed and retentate is shown in accordance with certain embodiments. Feed enters feed input 17 as depicted by arrow 117, and flows across the endcap 14A and inner plate 16 surfaces, across the flow channels defined by the membranes 15 (and screens 21 where present), as shown by arrows 117A, 117B and 117C, and exits through the retentate outlet (not shown in FIG. 7). Permeate flow is not shown in FIG. 7.

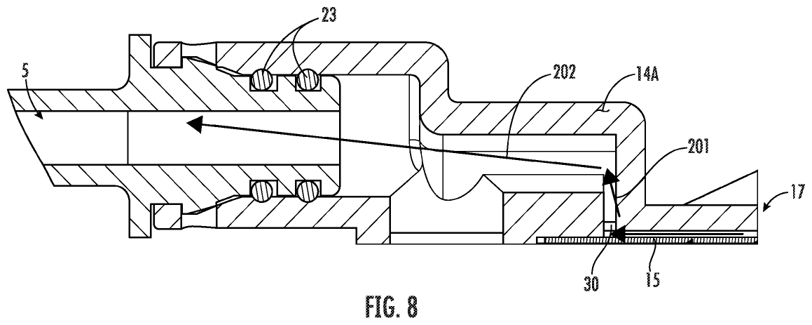

FIG. 8 shows permeate flow from the feed inlet 17 to the permeate outlet 5. Feed flow depicted by arrow 200 enters the feed inlet 17, such as through a feed barb, and flows across the endcap 14A surface and across the membrane 15 and screen if present (not shown in FIG. 8). Filtered permeate liquid, depicted by arrows 201 and 202, flows towards the permeate outlet 5 as shown.

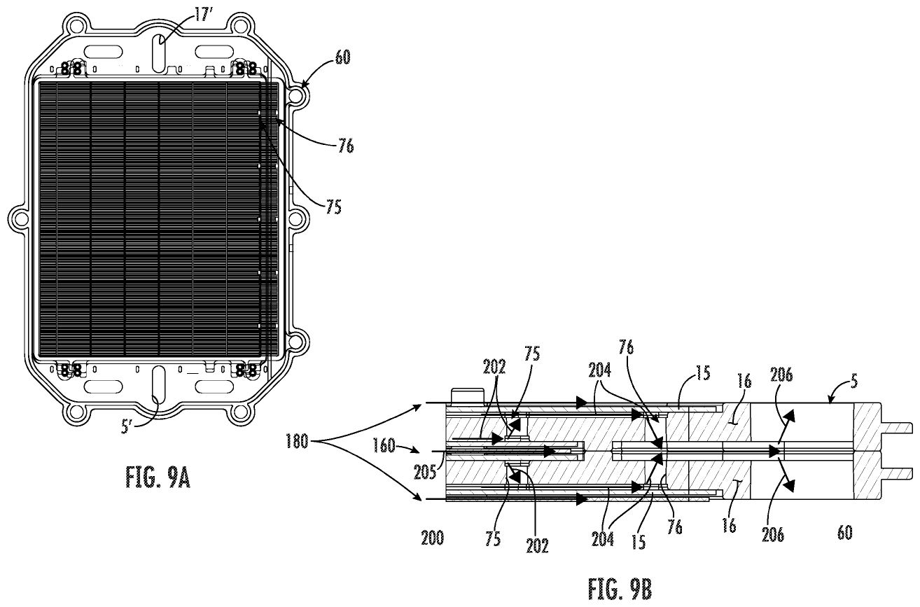

FIGS. 9A and 9B further illustrate permeate flow, now through a pair of inner plates 16 in accordance with certain embodiments. Feed liquid entering through opening 17′in fluid communication with feed inlet 17 of an endcap (not shown in FIGS. 9A and 9B) depicted by arrows 200 and 205 flows across the first surfaces or faces 180 of inner plate(s) 16 (arrows 200) and the second surfaces or faces 160 of inner plate(s) 16 (arrow 205) as shown. With regard to the permeate flow on the side of the second surface(s) 160, depicted by arrow 205, the fluid flows through the membranes 15 of each plate 16 along the small rib structure 26′ (not visible in FIG. 9B) to the permeate ports 75, and flows through the permeate ports 75 to the side of the first surface 180 of each plate 16, as depicted by arrows 202. With regard to the permeate flow on the side of the first surface(s) 180, the permeate fluid flows through the membranes 15, along the region of the small rib structure 26′, to the plurality of permeate ports 76, as depicted by arrows 204. All of the permeate fluid (whether from the first surface 180 or the second surface 160) thus flows through the plurality of ports 76 into open area on the side of the second surface 160, and then flows lengthwise in channel 77 until it reaches the permeate pipe feature 60, allowing it to flow to the permeate outlet 5 that is in fluid communication with the permeate channel 77. In this way, the permeate fluid flow through membranes 15 combines and flows towards the permeate outlet 5.

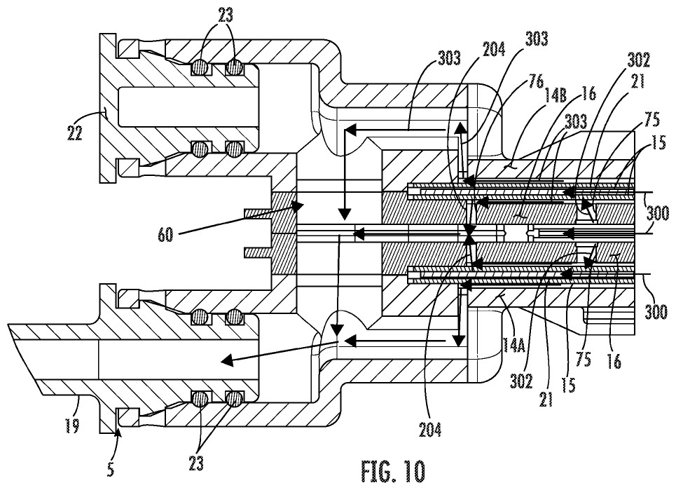

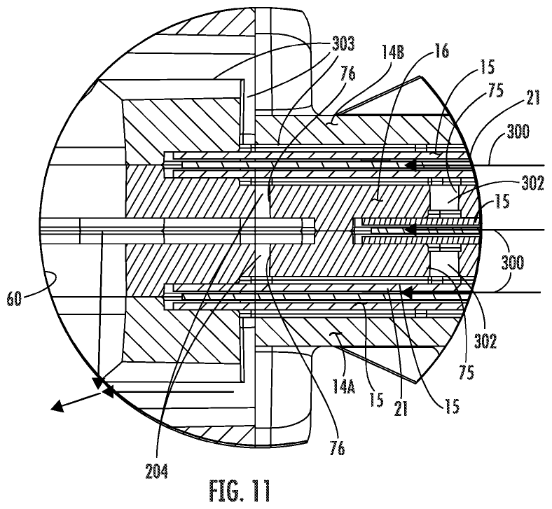

FIGS. 10 and 11 illustrate yet further details of permeate fluid flow. Arrows 300 depict feed flow entering through the feed inlet (not shown), after which it flows across the endcaps 14A, 14B and respective inner plate 16 surfaces, and across the membranes 15 and screens 21 associated therewith. The resulting filtered permeate that flowed through the membranes 15, combines, and flows towards the permeate outlet 5, as shown by arrows 303 in FIG. 10. More specifically, the permeate fluid flows through the membranes 15 to the permeate ports 75 (arrows 302), and flows through the permeate ports 75 to the side of the second surface. With regard to the permeate flow on the side of the first surface(s) 180, the permeate fluid flows through the membrane 15, along the region of the small rib structure 26′, to the plurality of permeate ports 76, as depicted by arrows 204. All of the permeate fluid (whether from the first surface 180 or the second surface 160) thus flows through the plurality of ports 76 into open area on the side of the second surface 160, and then flows lengthwise in channel 77 until it reaches the permeate pipe feature 60, allowing it to flow to the permeate outlet 5 in fluid communication therewith. In this way, the permeate fluid flow through membranes 15, combines, and flows towards the permeate outlet 5.

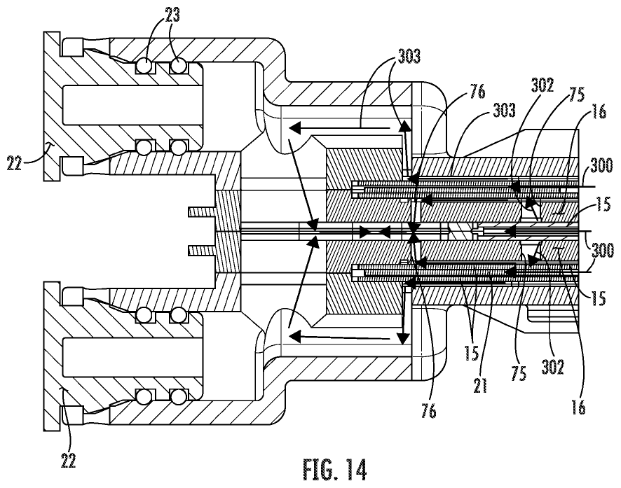

FIG. 14 still further illustrates permeate flow through a pair of inner plates 16, now near the end of the device having permeate plugs, away from the permeate barb. Feed flow 300 entering through a feed barb flows across the endcaps 14A, 14B and inner plate 16 surfaces, and across the membranes 15 and screens 21. The resulting permeate flows through the membranes 15, combines, and flows towards the permeate channel between the inner plates 16, and then through the permeate channel towards the permeate barb 19 at the other end of the device as depicted by the arrows.

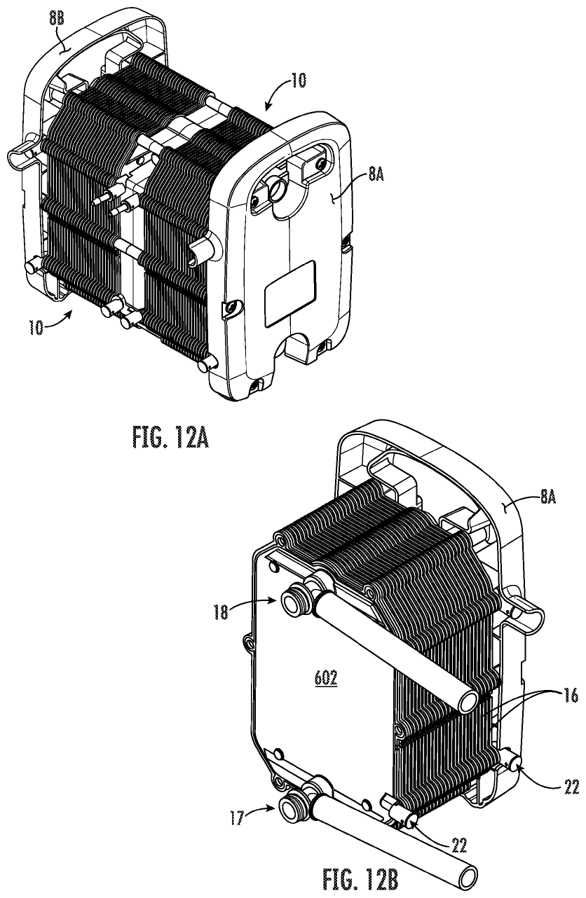

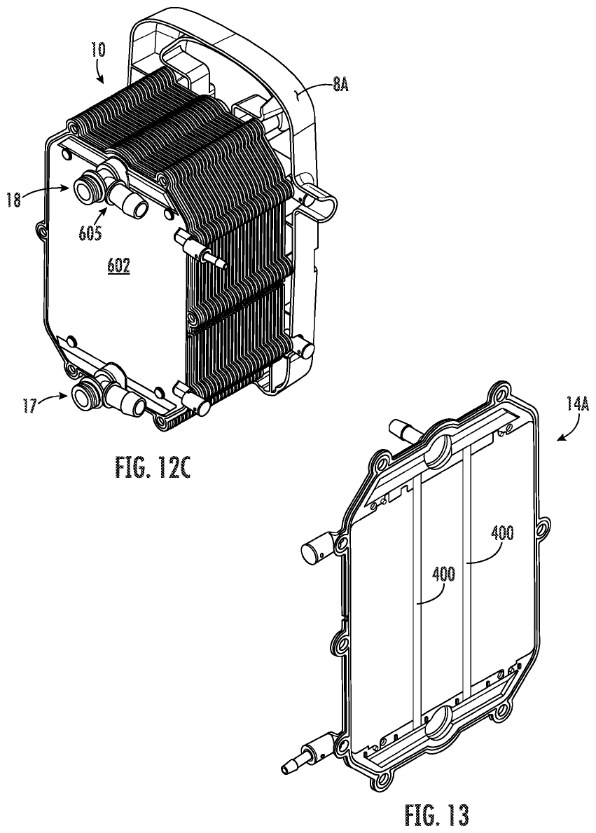

In some embodiments, as exemplified in FIGS. 12A, 12B and 12C, two or more devices 10 may be manifolded together, such as for higher throughput or capacity. External tubing (partially shown in FIG. 12B) may be used to join permeate output flows from each device, and combine those two flows together. In Some embodiments, feed and retentate lines are positioned at the center of the device and split out to the two filters. In some embodiments, a manifold tee 605 splits the feed and retentate flows for the two filters, and connects to tubing (FIG. 12B), FIGS. 12B and 12C also shows a center support plate 602 sandwiched between the two filters 10, supporting internal pressure.

While various aspects and embodiments have been disclosed herein, other aspects, embodiments, modifications and alterations will be apparent to those skilled in the art upon reading and understanding the preceding detailed description. The various aspects and embodiments disclosed herein are for purposes of illustration and are not intended to be limiting. It is intended that the present disclosure be construed as including all such aspects, embodiments, modifications and alterations insofar as they come within the scope of the appended claims or the equivalents thereof.

What is claimed is:

1. A tangential flow filter for filtration of a fluid, comprising:
first and second endcaps, and each of a fluid feed inlet, a retentate outlet and a permeate outlet on either said first or said second endcaps;
at least first and second plates, each plate having a first side and an opposite second side, said first side of said first plate facing said first endcap and having a first effective filtration area, said second side of said first plate facing said first side of said second plate and having a second effective filtration area;
filtration media between said first endcap and said first plate, between said first plate and said second plate, and between said second plate and said second endcap;
a first series of spaced openings through said first plate;
a second series of openings through said second plate in fluid communication with said first series of opening;
a third series of spaced openings through said first plate spaced from said first series of spaced openings;
a fourth series of openings through said second plate in fluid communication with said third series of opening;
wherein said third and fourth series of spaced openings are positioned in respective permeate channels in respective regions of said second side of said first plate and said first side of said second plate that are devoid of filtration media, said regions being opposite respective filtration media on said first side of said first plate and said second side of said second plate;
said permeate channel being in fluid communication with said permeate outlet.

2. The tangential flow filter of claim 1, wherein the openings of said first series of spaced openings are lineally aligned with each other.

3. The tangential flow filter of claim 1, wherein the openings of said third series of spaced openings are lineally aligned with each other.

4. The tangential flow filter of claim 1, wherein said filtration media between said first endcap and said first plate comprises a first membrane attached to said endcap and a second membrane attached to said first side of said first plate.

5. The tangential flow filter of claim 4, further comprising a screen between said first and second membranes.

6. The tangential flow filter of claim 4, wherein fluid passing through said second membrane flows through said third series of spaced openings and enters said permeate channel.

7. The tangential flow filter of claim 4, wherein fluid passing through said first membrane enters said permeate outlet.

8. The tangential flow filter of claim 1, wherein said filtration media between said first plate and said second plate comprises a third membrane attached to said second side of said first plate and a fourth membrane attached to said first side off said second plate.

9. The tangential flow filter of claim 8, wherein fluid passing through said third and fourth membranes enters each respective first and second series of spaced openings and flows to said third and fourth series of spaced openings.

10. The tangential flow filter of claim 1, further comprising a filtration media between said second side of said second plate and said second endcap.

11. A tangential flow filter for filtration of a fluid, comprising:
first and second endcaps, a fluid feed inlet, a retentate outlet and a permeate outlet on said first or second endcaps;
a plurality of pairs of plates between said first and second endcaps;
each of said pairs of said plurality of plates comprising at least first and second plates, each of said first and second plates having a first side and an opposite second side, said first side of said first plate having a first effective filtration area, said second side of said first plate facing said first side of said second plate and having a second effective filtration area;
filtration media on said first side and second side of each of said first and second plates;
a first series of spaced openings through said first plate;
a second series of openings through said second plate;
a third series of spaced openings through said first plate spaced from said first series of spaced openings;
a fourth series of openings through said second plate in fluid communication with said third series of openings in said first plate;
wherein said third and fourth series of spaced openings are positioned in respective permeate channels in respective regions of said second side of said first plate and said first side of said second plate that are devoid of filtration media, said regions being opposite respective filtration media on said first side of said first plate and said second side of said second plate;
said permeate channel being in fluid communication with said permeate outlet.

12. A method of filtering a fluid sample, comprising:
introducing said fluid sample into a feed inlet of a first endcap;
causing said introduced fluid sample to:
(a) contact a first membrane attached to said first endcap to form a first permeate flow and a first retentate flow, the first permeate flow flowing to a first permeate outlet of said first endcap or to a second permeate outlet of a second endcap, and said first retentate flow flowing to a first retentate outlet of said first endcap or a second retentate outlet of a second endcap;
(b) contact a second membrane attached to a first side of a first plate attached to said first endcap to form a second permeate flow and a second retentate flow, said second permeate flow flowing to a first spaced plurality of permeate ports formed in said first plate that are in fluid communication with a permeate channel and said first or second permeate outlet, said second retentate flow flowing to said first or second retentate outlet;
(c) contact a third membrane attached to a second side of said first plate to form a third permeate flow and a third retentate flow, said third permeate flow flowing to a second spaced plurality of permeate ports formed in said first plate and combining with said second permeate flow prior to said second permeate flow entering said first spaced plurality of permeate ports that are in fluid communication with said permeate channel and said first or second permeate outlet, said third retentate flow flowing to said first or second retentate outlet;
(d) contact a fourth membrane attached to a first side of a second plate attached to said first plate to form a fourth permeate flow and a fourth retentate flow, said fourth permeate flow flowing to a third spaced plurality of ports formed in said second plate and in fluid communication with a fourth spaced plurality of ports in fluid communication with said permeate channel and said permeate outlet, and said fourth retentate flow flowing to said first or second retentate outlet; and
(e) contact a fifth membrane attached to a second side of said second plate to form a fifth permeate flow and a fifth retentate flow, said fifth permeate flow flowing to said fourth spaced plurality of permeate ports formed in said second plate that are in fluid communication with said permeate channel and said first or second permeate outlet, said fifth retentate flow flowing to said first or second retentate outlet; and
(f) contact a sixth membrane attached to a second endcap to form a sixth permeate flow and a sixth retentate flow, the sixth permeate flow flowing to a permeate pipe in fluid communication with said permeate channel and said first or second permeate outlet and said sixth retentate flow flowing to said first or second retentate outlet; and
collecting permeate flow from said permeate outlet.

13. The method of claim 12, further comprising collecting retentate flow from said retentate outlet.

14. The method of claim 12, further comprising recycling retentate flow from said retentate outlet to said feed inlet.

15. The tangential flow filter of claim 1, wherein said second effective filtration area is less than said first effective filtration area.

16. The tangential flow filter of claim 1, wherein said second series of openings is aligned with said first series of openings.

17. The tangential flow filter of claim 1, wherein said third series of openings is aligned with said forth series of openings.
